(19) United States
(12) Patent Application Publication
(10) Pub. No.: US 2003/0155687 A1
(43) Pub. Date: Aug. 21, 2003

(54) Structural reaction injection molding process having void reduction

(76) Inventor: Joseph T. Donatti, Howell, MI (US)

Correspondence Address: BROOKS & KUSHMAN P.C. / LEAR CORPORATION, 1000 TOWN CENTER TWENTY-SECOND FLOOR, SOUTHFIELD, MI, 48075, US

(21) Appl. No.: 10/327,777

(22) Filed: Dec. 23, 2002

Related U.S. Application Data
(60) Provisional application No. 60/357,607, filed on Feb. 15, 2002.

(51) Int. Cl. B29C 70/42

(52) U.S. Cl. 264/257

(57) ABSTRACT

A structural reaction injecting molding process which includes the placing of a high loft glass mat in the mold prior to the injection of the polyurethane. The high loft glass mat is placed in the mold at a location where bubbles and voids are likely to occur. The high loft glass mat reduces the formation of bubbles and stabilizes the cell structure of the completed molded component.

### CROSS-REFERENCE TO RELATED APPLICATION

This application claims the benefit of U.S. provisional application Serial No. 60/357,607 filed Feb. 15, 2002.

### BACKGROUND OF THE INVENTION

1. Field of the Invention

The invention is related to structural reaction injecting molding (SRIM) processes and in particular to a structural reaction injection molding process having void reduction.

2. Background Art

The use of structural reaction injection molding processes to produce various components used in the fabrication of aircraft and automotive vehicles is well known in the art. These plastic molded components in many applications are highly desirable because they are strong, lightweight, dent-resistant and do not rust or corrode. Typical examples of the fabrication of such components and, in particular, door panels for automotive vehicles are taught by Altman et al. in U.S. Pat. No. 4,945,682 and Kobrehel in U.S. Pat. No. 5,927,020. In the alternative, Hipchen et al. in U.S. Pat. No. 4,386,983 teaches a method for making a structural laminate which may be used for a wide variety of applications.

The current processes for molding plastic components rely on process parameters being identified and controlled. Also, venting is commonly used to vent entrapped air. The processing window for SRIM doors or panels is very narrow and does not allow for tooling or process variations or variations in material component thickness. Faster cycle times can also narrow the process window due to the rapid gellation of the polyurethane while at the same time balancing the flow properties of the polyurethane to fill out the mold cavity before gellation is finished.

Another problem encountered is that as the injected polyurethane flows and begins to gel, gas bubbles are generated by the reaction of the polyol and other hydroxyl groups present with the isocyanate. The gas generated becomes entrapped between a cover film and the structural glass mat in the door composite. This entrapped gas can then develop bubbles and voids.

In addition to bubbles being formed during the reaction, air entrapment also occurs from the polyurethane dispensing apparatus during the dispensing of the polyurethane from the mix head onto the mold surface. While the polyurethane is being dispensed, the mix head is moved across the surface of the mold to fill the mold cavity. During this movement of the mix head, turbulence occurs. Turbulence is also produced by any protruding ribs in the mold. This turbulence also leads to the formation of bubbles and voids in the component being formed. Voiding can also occur based on the pour program or pattern used to wet out the mold.

The SRIM process disclosed herein is directed to the reduction of bubbles and voids and provide for faster cycle times.

### SUMMARY OF THE INVENTION

The invention is an SRIM process for plastic components directed to reducing voids in the finished product. The process involves placing a high loft glass mat in the region of the mold where bubbles and voids are most likely to occur prior to injecting the molding material into the mold cavity. The high loft glass mat acts as a filtering media breaking up the gas bubbles formed from the reaction of the polyol and isocyanate and the dispersing method.

In addition to breaking up the gas bubbles generated, the high loft glass mat acts as a cell stabilizer where the liquid polyurethane foam is encapsulated in the glass fiber construction in the pre-gellation state and during the gellation state. The encapsulation of polyurethane foam increases the strength of the cell wall formed during the reaction preventing collapse of the cell structure which forms voids. In addition to stabilizing cell structure, the high loft glass mat can also act as a vent mechanism allowing the gas to escape from the mold in a controlled manner.

One object of the invention is an SRIM process reducing voids in the molded component.

Another object of the invention is the placement of a high loft glass mat in the mold cavity in a region where bubbles and voids are likely to occur.

Another object of the invention is the use of a high loft glass mat to act as a stabilizer where the liquid foam is encapsulated.

Still another object of the invention is the use of a high loft glass mat to act as a vent mechanism allowing generated gas to escape from the mold.

These and other objects of the invention will become more apparent from a reading of the specification in conjunction with the drawings.

### BRIEF DESCRIPTION OF THE DRAWINGS

FIG. 1 is a plan view illustrating the vacuum forming of a thick film cover;

FIG. 2 is a plan view illustrating the placement of the pre-formed cover on the lower half of a two-part mold;

FIG. 3 is a plan view illustrating the placement of the plastic hooks on the top half of the two-part mold;

FIG. 4 is a plan view illustrating the placement of the fiberglass mat on the upper half of the two-part mold;

FIG. 5 is a plan view illustrating the placement of the high loft glass mat in the lower half of the two-part mold;

FIG. 6 is a side view of the two-part mold illustrating the injection of the polyurethane on the mold surface;

FIG. 7 is a cross-sectional view showing the two-part mold in the closed position;

FIG. 8 is a top view of a molded door panel; and

FIG. 9 is a flow diagram of the SRIM process according to the invention.

### DETAILED DESCRIPTION OF THE PREFERRED EMBODIMENT(S)

The invention relates to a method for injection molding a part or component, and in particular to a method using structural reaction injection molding (SRIM) processes. The processing window for molding components using SRIM processes is very narrow and does not allow for tooling or process variations, material variations and component thickness. Faster cycle times can also narrow the process window due to rapid gellation of the polyurethane while at the same time balancing the flow properties to fill out the mold cavity before gelatin is finished.

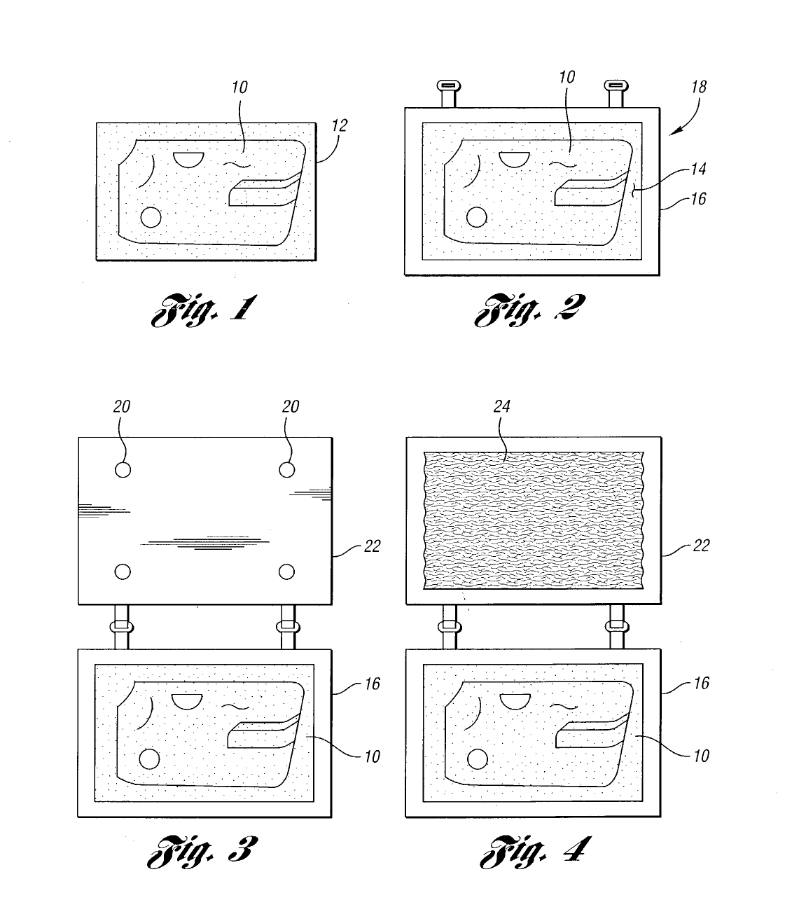

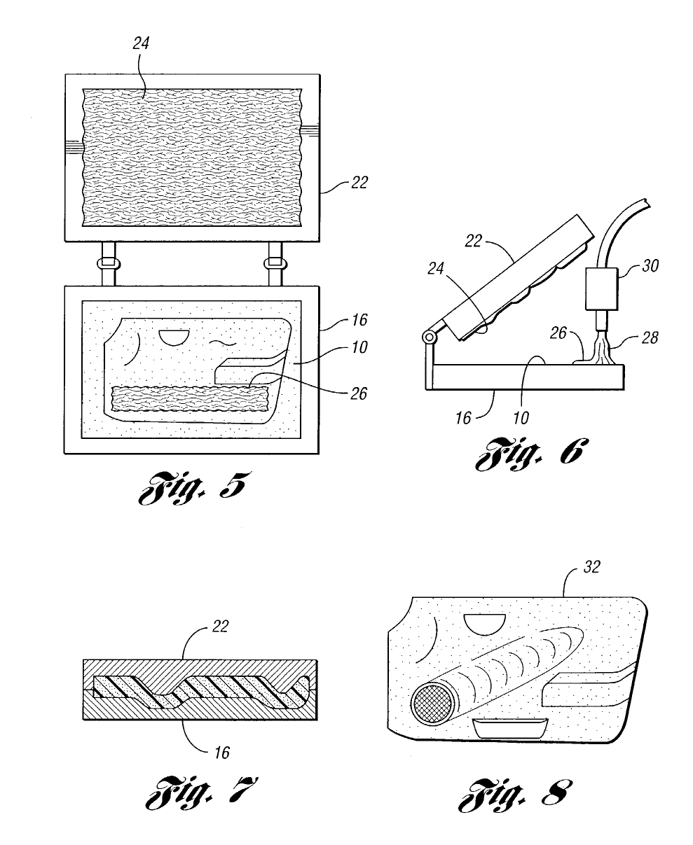

The invention will be discussed relative to the SRIM process for manufacturing an automotive door panel. However, it is recognized that the process is not limited to molding door panels nor is it limited to the molding of components for automotive vehicles. Referring first to FIG. 1, a cover 10 such as a polyvinyl, polyolefin or polyurethane film or any other type of such nonporous material is vacuum molded over a vacuum forming mold 12 to form the outer or surface layer of the finished article. This vacuum molding process is well known in the art and need not be further explained for an understanding of the invention. After the cover 10 is vacuum molded, it is trimmed to remove the unwanted edges and placed in the cavity 14 of the bottom half 16 of a two-(2) part mold 18, as shown in FIG. 2. After the vacuum formed cover 10 is loaded in the cavity 14 of the lower half 16 of the mold, locator hooks 20 are inserted into the upper half 22 as shown in FIG. 3. After the plastic hooks 20 are in place, a fiberglass mat 24 is attached to the plastic hooks 20 as shown on FIG. 4.

The key to the invention is illustrated in FIG. 5. As shown, a high loft glass mat 26 is placed in the cavity 14 of the lower mold. The high loft glass mat 26 is trimmed to fit the contour of the cavity 14 of the lower mold 16 and is placed in a location where bubbling and voiding occurs. In FIG. 5, the high loft glass mat 26 is placed near one edge of the mold, which in the particular illustration is the area where voids in the plastic are most commonly found. Alternatively, for other products, the high loft glass mat 26 may be placed along the top edge, or a side edge of the mold cavity 14 as may be determined to avoid voids.

The high loft glass mat 26 must be of sufficient weight and structure to allow the injected polyurethane foam to flow through before gellation occurs. It is recommended that the density of the high loft glass range from 0.15 percent to 0.3 percent and 5.0 to 6.0 grams per square foot for a thickness of the high loft glass mat in the range from 0.5 to 1.0 inches.

It is also recommended that the glass content of the high loft glass mat have a reduced surface tension to allow the polyurethane foam to flow more freely through the high loft glass mat. As the polyurethane flows through and begins to gel, gas bubbles are generated from the reaction of the polyol and other hydroxyl groups present with the isocyanate used to produce the polyurethane. The gas generated becomes trapped between the cover 10 and the structural glass mat 24. This entrapped gas then develops undesirable bubbles and voids between the cover and the glass mat 24.

In addition to bubbles being formed from the chemical reaction of the SRIM process, air entrapment also occurs from the polyurethane dispensing machine during the displacement of the polyurethane from the mix head onto the mold surface. While the polyurethane is being dispensed, the mix head is normally being moved across the mold surface. During this time, turbulence occurs from the mix head and any protruding ribs in the mold. This turbulence also leads to the formation of bubbles and voids in the component being molded. Voiding can also occur based on the pour program used to wet the mold.

The density of the high loft glass used in this invention is preferably about 5 grams per square foot, but higher or lower weights per square foot may be used depending on the SRIM system chemistry, the mold design and the material construction. The high loft glass mat 26 acts as a filtering media, breaking up the gas bubbles formed from the reaction of the polyol and isocyanate, the dispensing method and the mold configuration. In addition to breaking the gas bubbles generated, the high loft glass mat 26 also acts as a cell stabilizer where the liquid foam is encapsulated in the glass fibers in the pre-gellation state and during the gellation stage. This encapsulation of the polyurethane increases the strength of the cell wall formed during the reaction preventing collapse of the cell structure. As is known, the prevention of the collapse of the cell structure prevents voids.

In addition to stabilizing the polyurethane cell structure, the high loft glass mat 26 can also act as a vent mechanism allowing gas to escape from the mold 18 in a controlled manner. The high loft glass mat must be positioned along the perimeter of the mold and locked into position to act as a venting and cell stabilizing media. In order to prevent what is called “drop spots”, the polyurethane must be in a liquid phase when it comes into contact with the high loft glass mat. If the polyurethane is in the gellation phase, it will not fully penetrate the high loft fiberglass mat and “drop spots” can occur.

The uniqueness of the use of the high loft fiberglass mat is that the high loft glass mat must be of a very open construction and loft to fill out the cavity of the mold where bubbles and voiding can occur. The weight and geometry of the high loft glass mat is also important and must be sized for the mold and the reactivity of the SRIM process used to mold the component.

FIG. 6 is a side view of the mold 18 in a partially closed state. As shown, the polyurethane 28 is injected into the cavity 14 from SRIM mix head 30 which receives the requisite polyol, isocyanate, and other chemical reactants from external sources (not shown). The polyol, isocyanate and reactive chemicals are mixed in the mix head 30 and injected into the cavity 14 of the lower mold 16 in a prescribed pattern. As discussed above, the polyurethane is first injected into the mold 16 in the region of the high loft glass mat 26 when it is in the liquid phase.

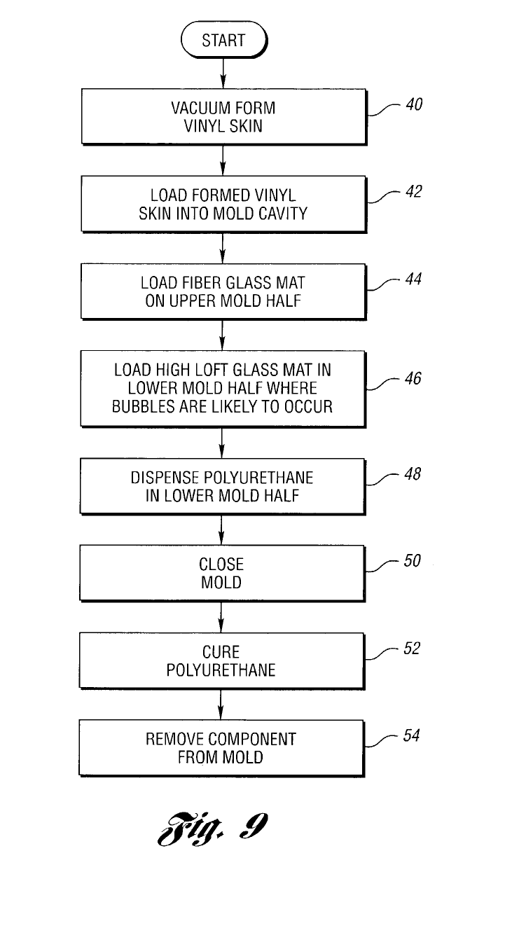

After the required amount of polyurethane is injected in the mold 18, the mold is closed and the polyurethane composite is cured as shown in FIG. 7. After curing, the molded component 32 such as a molded door panel is removed from the mold 18 as shown on FIG. 8.

FIG. 9 is a flow diagram of the molding process. The process begins by vacuum forming a vinyl skin or cover 10 as indicated by block 40. The formed vinyl cover 10 is then loaded onto the bottom half of the two-part mold as indicated by block 42. A fiberglass mat, such as mat 24 is loaded onto the upper half 22 of two-part mold 18 and a high loft glass mat such as high loft glass mat 26 is placed in the cavity of the lower mold half as indicated by blocks 44 and 46, respectively. As previously indicated, the high loft glass mat 26 is placed into an area where bubbles and voids are likely to occur. The polyurethane is then dispensed over the surface of the lower mold as indicated by block 48 starting with the area where the high loft glass mat is located. The mold 18 is then closed and the polyurethane cured as indicated by blocks 50 and 52, respectively. The mold may be heated to accelerate the curing of the rigid polyurethane. After curing the molded component is removed, block 54, from the mold completing the process.

While one embodiment of the invention have been illustrated and described, it is not intended that this embodiment illustrates and describes all possible forms of the invention. Rather, the words used in the specification are words of description rather than limitation, and it is understood that various changes may be made without departing from the spirit and scope of the invention.

What is claimed is:

1. A method for molding a plastic component comprising:
placing a fiberglass mat on the surface of the upper half of a two-part mold;
placing a high loft glass mat in the cavity of a lower half of the two-part mold; said high loft glass mat being placed in a location where bubbles and voids are likely to occur;
dispensing a liquid plastic material into the lower half of the two-part mold covering the surface of the mold and the high loft glass mat;
closing the two-part mold;
curing the liquid plastic material; and
opening the two-part mold and removing the molded component.

2. The method of claim 1 wherein the step of dispensing dispenses a structural reaction injecting molding material on the bottom half of the two-part mold.

3. The method of claim 2 wherein the structural reaction injection molding material is polyurethane.

4. The method of claim 3 wherein the polyurethane is produced by mixing at least a polyol and an isocyanate in a mix head prior to being dispensed.

5. The method of claim 2 wherein the structural reactive injection molding material is in a liquid state when dispensed on the high loft glass mat.

6. The method of claim 1 further including loading a pre-formed cover film into the lower half of the two-part mold prior to placing the high loft glass mat into the cavity of the lower half of the two-part mold.

7. The method of claim 6 wherein the pre-formed cover film is a pre-formed material selected from the group consisting of polyvinyl, polyolefin and polyurethane film.

8. A method for improving a structural reaction injection molding process for void reduction comprising:
placing a high loft glass mat on the lower half of a two-part mold in a region where bubbles and voids in an injected plastic material can occur;
dispensing the SRIM material on the lower half of the two-part mold;
closing the mold; and
curing the SRIM material in the two-part mold.

9. The method of claim 8 including the step of treating the glass in the high loft glass mat to reduce surface tension.

10. The method of claim 9 wherein the step of dispensing includes the step of mixing polyol and isocyanate in a mix head to generate polyurethane just prior to dispensing.

11. The method of claim 9 wherein the polyurethane is dispensed over the high loft glass mat in a liquid state prior to gellation.

12. A method for molding a door panel comprising:
attaching a glass mat to the upper half of a two-part mold;
placing a high loft glass mat on the lower half of the two-part mold in a region where bubbles and voids could be generated;
mixing polyol and at least isocyanate to form polyurethane;
dispensing the polyurethane on the lower half of the two-part mold and the high loft glass mat;
closing the two-piece mold and curing the polyurethane; and
removing the molded door panel from the mold after the polyurethane is cured.

13. The method of claim 12 further including placing a pre-formed cover film in the lower half of the two-part mold prior to placing the high loft glass mat in the lower half of the two-part mold.

14. The method of claim 13 where the pre-formed cover film is a polyvinyl cover film.

15. The method of claim 12 further comprising treating the glass of the light loft glass mat to reduce surface tension.
